(19) United States
(12) Patent Application Publication
(10) Pub. No.: US 2003/0143948 A1
(43) Pub. Date: Jul. 31, 2003

(54) Apparatus and method for detecting base station direction in RF repeater

(76) Inventors: Gyu-Duk Han, Seoul (KR); Hai-Yong Lee, Sungnam-city (KR)

Correspondence Address: RADER FISHMAN & GRAUER PLLC, LION BUILDING, 1233 20TH STREET N.W., SUITE 501, WASHINGTON, DC, 20036, US

(21) Appl. No.: 10/105,380

(22) Filed: Mar. 26, 2002

(30) Foreign Application Priority Data
Jan. 28, 2002 (KR) 2002-4796

(51) Int. Cl. H04B 7/15

(52) U.S. Cl. 455/11.1; 455/561; 455/424

(57) ABSTRACT

Disclosed is a method for detecting base station direction in a RF repeater installed for providing mobile communication service to shadow areas. The method for detecting base station direction in the RF repeater includes the steps of: moving an antenna in various directions and storing downlink input value into a buffer at prescribed time intervals; extracting the maximum value from the downlink input value and storing into a resistor; when the value stored in the resistor is equal to the downlink input value, displaying it; and installing the RF repeater at the displayed position. Therefore, the RF repeater can be easily installed by finding an optimum base station direction without using any special equipment.

### BACKGROUND OF THE INVENTION

1. Field of the Invention

The present invention relates to a mobile radio communication system, and more particularly, to an apparatus and a method for detecting a base station direction in an RF repeater, which can detect direction of a base station (BTS) through the RF repeater installed for providing services to shadow area consumers.

2. Background of the Related Art

Recently, with rapid development in a mobile communication service, users' using aspects and desires are varied, such that the users want to communicate without any restriction in time and space. However, electric wave transmitted from a base station cannot reach to the inside of large-sized buildings, the back of mountains or hills, or the inside of tunnels or subway stations, and thereby the mobile communication service may be interrupted in the above areas.

To solve the above problem, a repeater, which is inexpensive and provides the same services as the base station, is used instead of installing the expensive base station.

The repeater is a system to provide good quality communication service also to a shadow areas by receiving signal of the base station through another path, amplifying the signal into the same signal as the base station and transmitting it to the users. So that the repeater is on the rise as an essential equipment in a mobile communication network. Furthermore, the repeater is used as a good alternative measure in isolated villages or in areas where installation of the base station is not economic because of low telephonic communication such like an island.

FIG. 1 illustrates a layout view of a conventional RF repeater. The conventional RF repeater includes a base telecommunication station (BTS), the master station for transmitting RF signal, and at least one or more of repeaters for amplifying the RF signal of the BTS and transmitting it to subscribers or for amplifying signal of the subscribers and transmitting it to the BTS.

The RF repeater receives signal transmitted from the BTS through an antenna of the repeater and amplifies it sufficiently enough to provide communication service to the shadow area. In the case to the contrary, the RF repeater amplifies signal of the users and transmits it to the BTS through the opposite path.

Therefore, conventionally, there are two methods for installing the RF repeater; one being a method for installing the repeater after checking a direction at a visible position between the BTS and the antenna, and the other being a method for installing the repeater after finding a position corresponding to the maximum value of input signal using a spectrum device or a power meter.

The conventional RF repeater installed by one of the above methods is in need of special equipments. Moreover, in case of popular type RF repeaters installed in offices, it is difficult to locate and install the BTS and the antenna in a correct direction.

### SUMMARY OF THE INVENTION

Accordingly, the present invention is directed to an apparatus and a method for detecting base station direction in RF repeater that substantially obviates one or more problems due to limitations and disadvantages of the related art.

An object of the present invention is to provide an apparatus for detecting base station direction in an RF repeater capable of finding optimum base station direction without using special equipments and easily installing the RF repeater.

Another object of the present invention is to provide an apparatus for detecting base station direction in an RF repeater, which can easily detect the optimum output value corresponding to input value by manipulating a button after storing downlink input value into a microprocessor at regular time intervals.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for detecting base station direction in an RF repeater includes: a downlink RF receiving part for transmitting and receiving RF signal from a base station; an RF output level detecting part for detecting output signal of the RF receiving part; a central processing unit (CPU) for storing the RF output signal, detected from the RF output level detecting part, into a corresponding address; key input parts connected to an input terminal of the CPU and checking displacement amount of the RF signal; and a display part connected to an output terminal of the CPU and turned on and off according to the displacement amount of the RF signal.

In another aspect of the present invention, a method for detecting base station direction in an RF repeater according to the present invention includes the steps of: moving an antenna in various directions and storing downlink input value into a buffer at prescribed time intervals; extracting the maximum value from the downlink input value and storing it into a resistor; displaying the identity of both values when the value stored in the resistor is found to be equal to the downlink input value; and installing the RF repeater at the displayed position.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a layout view of a conventional RF repeater;

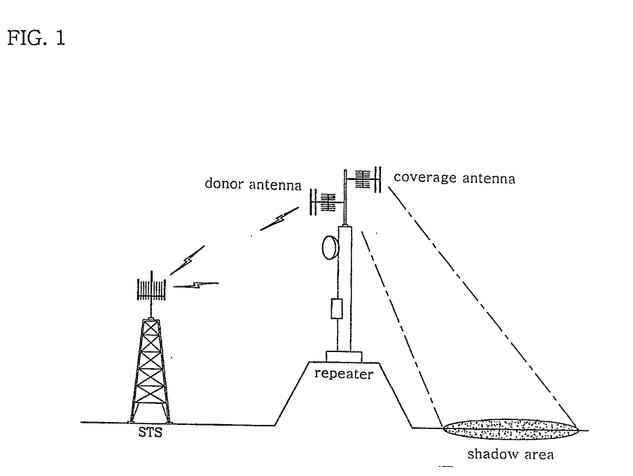

FIG. 2 illustrates a circuit view of a RF repeater according to the present invention; and

FIG. 3 illustrates a flow chart of a method for detecting base station direction using the RF repeater according to the present invention.

### DETAILED DESCRIPTION OF THE PREFERRED EMBODIMENT

Reference will now be made in detail to the preferred embodiments of the present invention, examples of which are illustrated in the accompanying drawings.

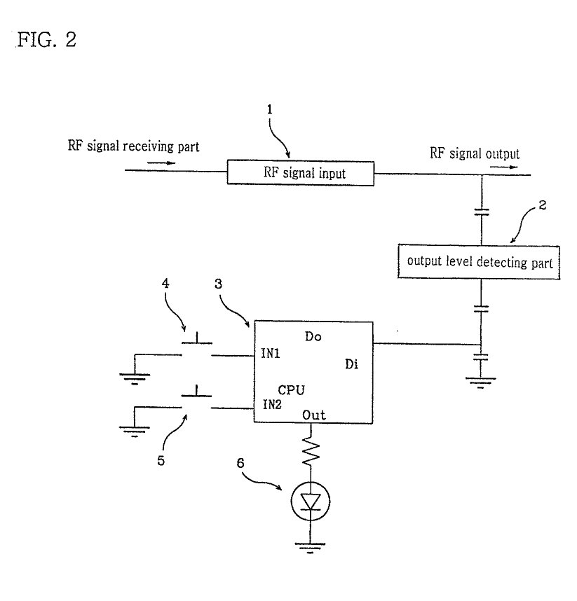

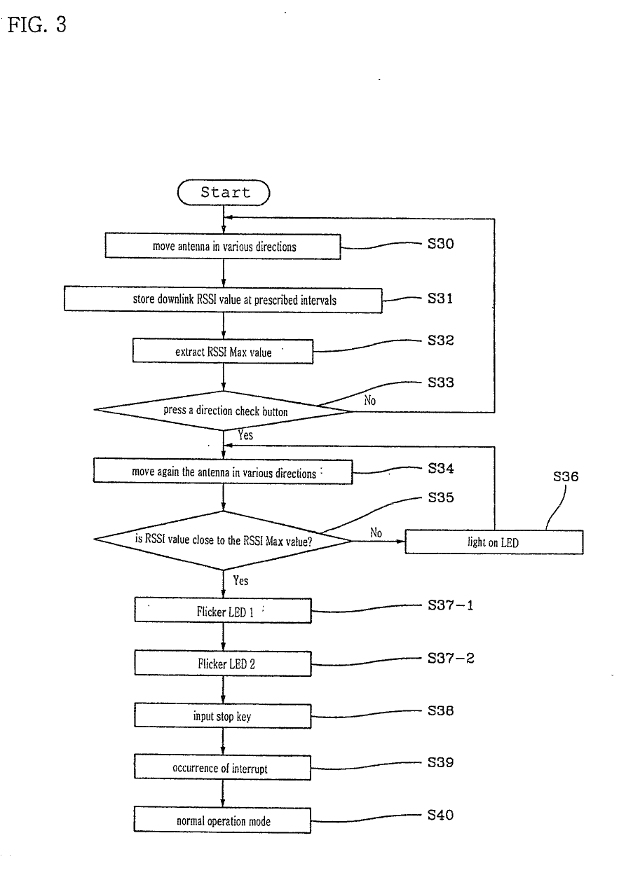

FIG. 2 illustrates a circuit view of a RF repeater according to the present invention, and FIG. 3 illustrates a flow chart of a method for detecting base station direction using the RF repeater according to the present invention.

Referring to FIG. 2, an apparatus for detecting base station direction in the RF repeater according to the present invention includes a downlink RF receiving part 1 for transmitting and receiving RF signal from a base station (not shown), an RF output level detecting part 2 for detecting output signal of the RF receiving part 1, a central processing unit (CPU) 3 for storing the RF output signal detected from the RF output level detecting part 2 into a corresponding address, key input parts 4 and 5 connected to an input terminal of the CPU 3 and checking displacement amount of the RF signal, and a display part 6 connected to an output terminal of the CPU 3 and turned on and off according to the displacement amount of the RF signal.

Referring to the flowchart of FIG. 3, function and effect of the apparatus for detecting the base station direction in the RF repeater will be described as follows.

In the method for detecting the base station direction in the RF repeater according to the present invention, first, an antenna of the RF repeater to be installed moves in various directions (S30).

At this time, the RF signal is inputted into the RF signal receiving part 1 which then amplified and output into a prescribed level. The output level detecting part 2 detects the RF output signal and temporarily stores detected downlink input value in an internal buffer of the CPU 3 at regular intervals (S31).

The maximum value (RSSI_Max) of the downlink input value (RSSI) is extracted and stored in a resistor (S32).

An installer moves the antenna in various directions while pressing a direction check button 4 of the key input parts (S34). At this time, the installer takes aim an installation position in an optimum direction while checking repeatedly (S35) whether or not the downlink input value (RSSI) is close to the maximum value (RSSI_Max).

Here, when the value stored in the resistor is equal to the downlink value (RSSI), the light emission diode (LED) 6 is turned on and off (S37-1) (S37-2), but if the value is not equal to the downlink value, the LED 6 is lighted (S36). If the LED 6 is lighted, the checking step (S35) is carried out repeatedly.

Finally, after the RF repeater is installed, when the end key 5 is input (S38), the CPU 3 is interrupted (S39) and then operated in a normal mode (S40).

As described above, the apparatus and method for detecting a base station direction in an RF repeater according to the present invention are economic because the RF repeater is easily installed in an optimum base station direction without any help of special equipments.

Therefore, the apparatus and method for detecting the base station direction in the RF repeater according to the present invention may have different optimum values, stored in a resistor, according to a downlink input value, and installation position of the RF repeater can be changed according to the optimum value. So, the forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for detecting base station direction in an RF repeater, the apparatus comprising:
a downlink RF receiving part for transmitting and receiving RF signal from a base station;
an RF output level detecting part for detecting output signal of the RF receiving part;
a central processing unit (CPU) for storing the RF output signal detected from the RF output level detecting part into a corresponding address;
key input parts connected to an input terminal of the CPU and checking displacement amount of the RF signal; and
a display part connected to an output terminal of the CPU and turned on and off according to the displacement amount of the RF signal.

2. A method for detecting base station direction in an RF repeater, the method comprising the steps of:
moving an antenna in various directions and storing downlink input value into a buffer at prescribed time intervals;
extracting the maximum value from the downlink input value and storing into a resistor;
when the value stored in the resistor is equal to the downlink input value, displaying it; and
installing the RF repeater at the displayed position.
